(19) United States
(12) Patent Application Publication
(10) Pub. No.: US 2015/0301640 A1
(43) Pub. Date: Oct. 22, 2015

(54) INPUT DEVICE, DISPLAY DEVICE, AND ELECTRONIC APPARATUS

(71) Applicant: KYOCERA CORPORATION, Kyoto-shi, Kyoto (JP)

(72) Inventor: Kouji TSURUSAKI, Kirishima-shi (JP)

(73) Assignee: KYOCERA CORPORATION, Kyoto-shi, Kyoto (JP)

(21) Appl. No.: 14/436,385

(22) PCT Filed: Nov. 6, 2013
(86) PCT No.: PCT/JP2013/079961

§ 371 Date: Apr. 16, 2015

(30) Foreign Application Priority Data
Dec. 26, 2012 (JP) 2012-283053

(51) Int. Cl. G06F 3/042

(52) U.S. Cl. CPC G06F 3/042

(57) ABSTRACT

An input device includes a base, a first light shielding layer that is provided on the base and has an opening, and a second light shielding layer that is provided on the first light shielding layer and placed in such a manner that surrounds the opening in a planar view. The input device has an input region and a non-input region, and it is preferable that the first light shielding layer and the second light shielding layer be placed on the non-input region.

### FIELD

The present invention relates to an input device, a display device, and an electronic apparatus.

### BACKGROUND

Such a conventional input device is known that includes a base and a light shielding layer with an opening. The opening is, for example, in the shape of a specific letter or graphic and has a function to display the letter or the graphic by making a part of or the whole of light entering from a light source penetrate the opening (see Patent Literature 1 as an example).

However, there has been the possibility that such an input device may fail to sufficiently shield the light on the light shielding layer positioned in the vicinity of the outer edge of the opening when a relatively large amount of light enters from the light source, for example. If the light cannot be sufficiently shielded on the light shielding layer positioned in the vicinity of the outer edge of the opening, the outer edge of the opening is likely to be visually indistinctly recognized.

### CITATION LIST

### Patent Literature

Patent Literature 1: Japanese Patent Application Laid-open No. 2011-13761

### SUMMARY

From the viewpoint of the above-described problems, an object of the present invention relates to an input device, a display device, and an electronic apparatus that can reduce the possibility that the outer edge of an opening is visually indistinctly recognized.

An input device comprises a base, a first light shielding layer that is provided on the base and has an opening, and a second light shielding layer that is provided on the first light shielding layer and is placed in such a manner that surrounds the opening in a planar view.

A display device comprises the input device, a display panel that is arranged in such a manner that faces the input device, and a first housing that accommodates the display panel.

An electronic apparatus comprises the display, wherein the first housing of the display device serves as a housing of the electronic apparatus.

### BRIEF DESCRIPTION OF DRAWINGS

FIG. 1 is a planar view that illustrates the general configuration of an input device according to an embodiment.

FIG. 2 is a sectional view along the I-I line illustrated in FIG. 1.

FIG. 3 is a sectional view along the II-II line illustrated in FIG. 1.

FIG. 4 is a sectional view along the III-III line illustrated in FIG. 1.

FIG. 5 is a planar magnification view of an area A1 circled with a dotted-chain line illustrated in FIG. 1.

FIG. 6 is a sectional view along the IV-IV line illustrated in FIG. 5.

FIG. 7 illustrates questionnaire results that indicate effects relating to the input device according to the embodiment.

FIG. 8 is a planar view that illustrates the general configuration of a display device according to the embodiment.

FIG. 9 is a sectional view along the V-V line illustrated in FIG. 8.

FIG. 10 is a sectional view along the VI-VI line illustrated in FIG. 8.

FIG. 11 is a perspective view that illustrates the general configuration of a mobile terminal according to the embodiment.

FIG. 12 is a planar view that illustrates the general configuration of an input device according to a first modification.

FIG. 13 is a planar magnification view of an area A2 circled with a dotted chain line illustrated in FIG. 12.

FIG. 14 is a sectional view along the VII-VII line illustrated in FIG. 13.

FIG. 15 is a planar view that illustrates the general configuration of an input device according to a second modification.

FIG. 16 is a sectional view along the VIII-VIII line illustrated in FIG. 15.

FIG. 17 is a planar magnification view of an area A3 circled with a dotted chain line illustrated in FIG. 15.

FIG. 18 is a sectional view along the IX-IX line illustrated in FIG. 17.

FIG. 19 is a planar view that illustrates the general configuration of an input device according to a third embodiment.

FIG. 20 is a sectional view along the X-X line illustrated in FIG. 19.

FIG. 21 is a planar magnification view of an area A4 circled with a dotted chain line illustrated in FIG. 19.

FIG. 22 is a sectional view along the XI-XI line illustrated in FIG. 19.

### DESCRIPTION OF EMBODIMENTS

An embodiment of the present invention will now be described with reference to the drawings.

For convenience, each drawing referred to in the following simplistically illustrates only main members necessary to describe the present invention out of structural members of an embodiment of the present invention. An input device, a display device, and an electronic apparatus according to the present invention thus can include any structural members not illustrated in the drawings referred to in the description.

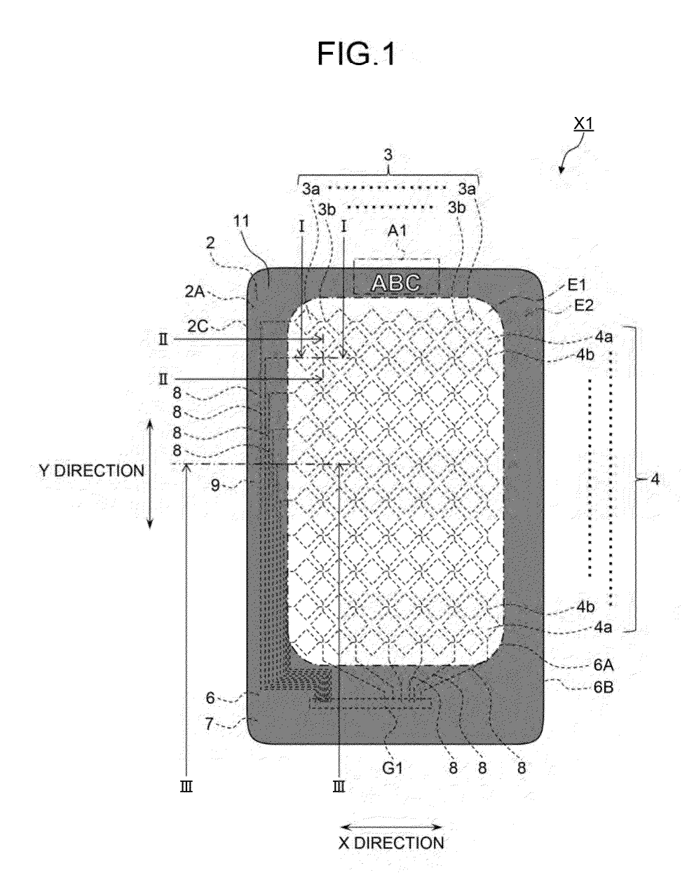

As illustrated in FIG. 1, an input device X1 according to the embodiment is a projected capacitive touch panel and has an input region E1 and a non-input region E2. The input region E1 is a region where a user can perform an input operation. The non-input region E2 is a region where a user cannot perform an input operation. The non-input region E2 according to the embodiment is positioned outside the input region E1 in such, a manner that surrounds the input region E1. In the embodiment, the non-input region E2 indicates a region surrounded by a peripheral surface 2C of a base 2 and an inner edge 6A of a first light shielding layer 6, which will be described later, in a planar view. The non-input region E2 may be positioned inside the input region E1. In this case, the non-input region E2 indicates a region surrounded by the inner edge 6A and an outer edge 6B of the first light shielding layer 6 in a planar view.

The input device X1 is not limited to a projected capacitive touch panel. Examples of the input device X1 may include, but are not limited to, a surface capacitive touch panel, a resistive film touch panel, a surface acoustic wave touch panel, an optical touch panel, and an electromagnetic induction touch panel.

Furthermore, the input device X1 is not limited to the above-described touch panel. Examples of the input device X1 may include, but are not limited to, a voice recognition device that analyses a voice signal output from a voice of a user and performs input processing, a line-of-sight input device that detects a change of the line-of-sight direction of a user moving his/her eyeballs and performs input processing, a gesture input device that performs input processing in response to a gesture of a user, and other kinds of input devices.

The input device X1 includes the base 2, a first detection electrode pattern 3, a second detection electrode pattern 4, an insulating body 5 the first light shielding layer 6, a first protection layer 7, a detection wire 8, a second protection layer 9, a second light shielding layer 10, and a protection sheet 11.

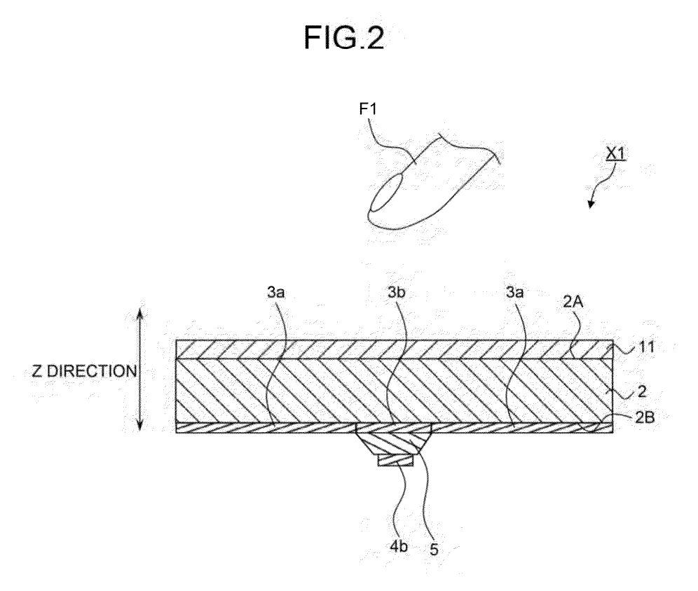

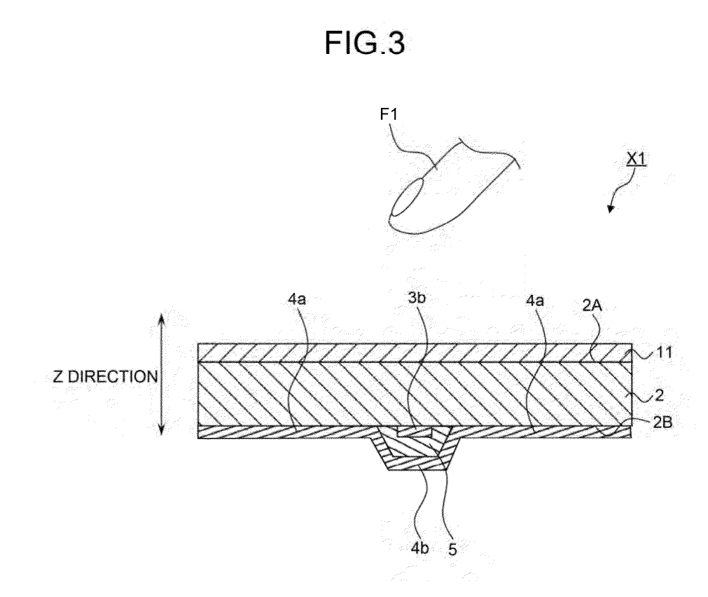

First of all, the base 2, the first detection electrode pattern 3, the second detection electrode pattern 4, and the insulating body 5 will be described in detail with reference to FIGS. 1 to 4. In FIG. 1, the insulating body 5 is not illustrated for convenience of description.

The base 2 serves a role of supporting the above-described members. The base 2 has a first main surface 2A, a second main surface 2B, and the peripheral surface 2C. The first main surface 2A is in a position closer to a user than the second main surface 2B. The second main surface 2B is positioned opposite to the first main surface 2A. The peripheral surface 2C is positioned between the first main surface 2A and the second main surface 2B. In the embodiment, the base 2 is substantially in a rectangular shape in a planar view. Four peripheral surfaces 2C are thus provided in such a manner that corresponds to four sides of the base 2 in a planar view. The base 2 may be, for example, in an elliptical shape or in a polygonal shape in a planar view.

The base 2 has insulating properties. The base 2 is translucent to the light entering in the directions intersecting with the first main surface 2A and with the second main surface 2B. Examples of the structural material of the base 2 include, but are not limited to, glass and plastic.

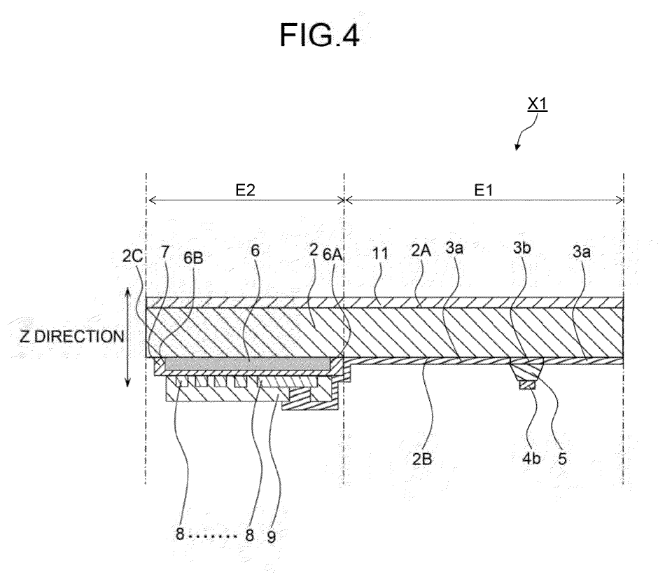

The first detection electrode pattern 3 serves a role of detecting an input position in the long side direction (the Y direction in FIG. 1) of the base 2 in a planar view by generating electrostatic capacitance between the first detection electrode pattern 3 and a finger F1 of a user approaching an area corresponding to the input region E1 on the first main surface 2A of the base 2. A plurality of first detection electrode patterns 3 are aligned in the Y direction on an area corresponding to the input region E1 on the second main surface 2B of the base 2. As illustrated in FIG. 4, some of the first detection electrode patterns 3 extend from the input region E1 into the non-input region E2 so as to be electrically connected with the later-described detection wire 8. The first detection electrode pattern 3 has a first detection electrode 3a and a first interelectrode wire 3b.

The first detection electrode 3a serves a role of generating electrostatic capacitance between the first detection electrode 3a and the finger F1 of a user. A plurality of first detection electrodes 3a are aligned in the short side direction (the X direction In FIG. 1) of the base 2 in a planar view. The first interelectrode wire 3b serves a role of electrically connecting the first detection electrodes 3a with one another. The first interelectrode wire 3b is provided between the first detection electrodes 3a adjacent to one another.

The second detection electrode pattern 4 serves a role of detecting an input position in the X direction by generating electrostatic capacitance between the second detection electrode pattern 4 and the finger F1 of a user approaching an area corresponding to the input region E1 on the first main surface 2A of the base 2. A plurality of second detection electrode patterns 4 are aligned in the X direction on an area corresponding to the input region E1 on the second main surface 2B of the base 2. As illustrated in FIG. 4, some of the second detection electrode patterns 4 extend from the input region E1 into the non-input region E2 so as to be electrically connected with the later-described detection wire 8. The second detection electrode pattern 4 has a second detection electrode 4a and a second interelectrode wire 4b.

The second detection electrode 4a serves a role of generating electrostatic capacitance between the second detection electrode 4a and the finger F1 of a user. A plurality of second detection electrodes 4a are aligned in the Y direction. The second interelectrode wire 4b serves a role of electrically connecting the second detection electrodes 4a with one another. The second interelectrode wire 4b is provided between the second detection electrodes 4a adjacent to one another and provided on the insulating body 5 with the insulating body 5 interposed between the second interelectrode wire 4b and the first interelectrode wire 3b so as to be electrically insulated from the first interelectrode wire 3b. The insulating body 5 is provided on the second main surface 2B of the base 2 in such a manner that covers the first interelectrode wire 3b. Examples of the structural material of the insulating body 5 include, but are not limited to, transparent resin such as acrylic resin, epoxy resin, silicone resin, silicon dioxide, and silicon nitride.

Examples of the structural material of the above-described first detection electrode pattern 3 and the second detection electrode pattern 4 include, but are not limited to, a translucent conductive material. Examples of such a translucent conductive material include, but are not limited to, indium tin oxide (ITO), indium zinc oxide (IZO), al-doped sine oxide (AZO), tin oxide, zinc oxide, and conductive polymers.

As a method to form the first detection electrode pattern 3 and the second detection electrode pattern 4, for example, sputtering, vapor deposition, and chemical vapor deposition (CVD) are used to form a film from the above-described materials on the second main surface 2B of the base 2. The first detection electrode pattern 3 and the second detection electrode pattern 4 are formed by applying light sensitive resin to the surface of the film and patterning the film through exposure, development, and etching processes.

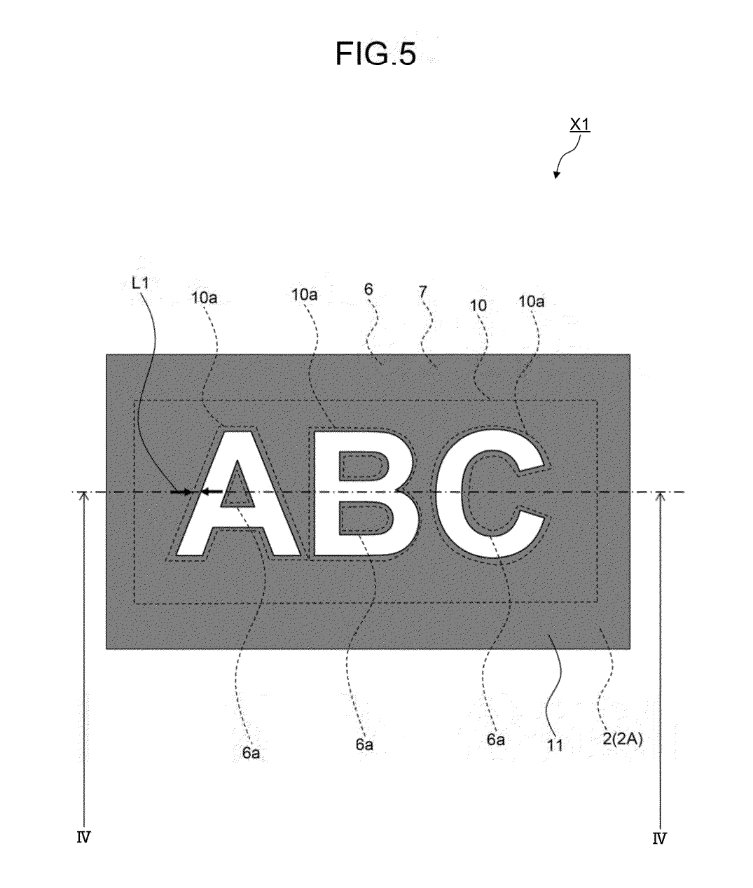

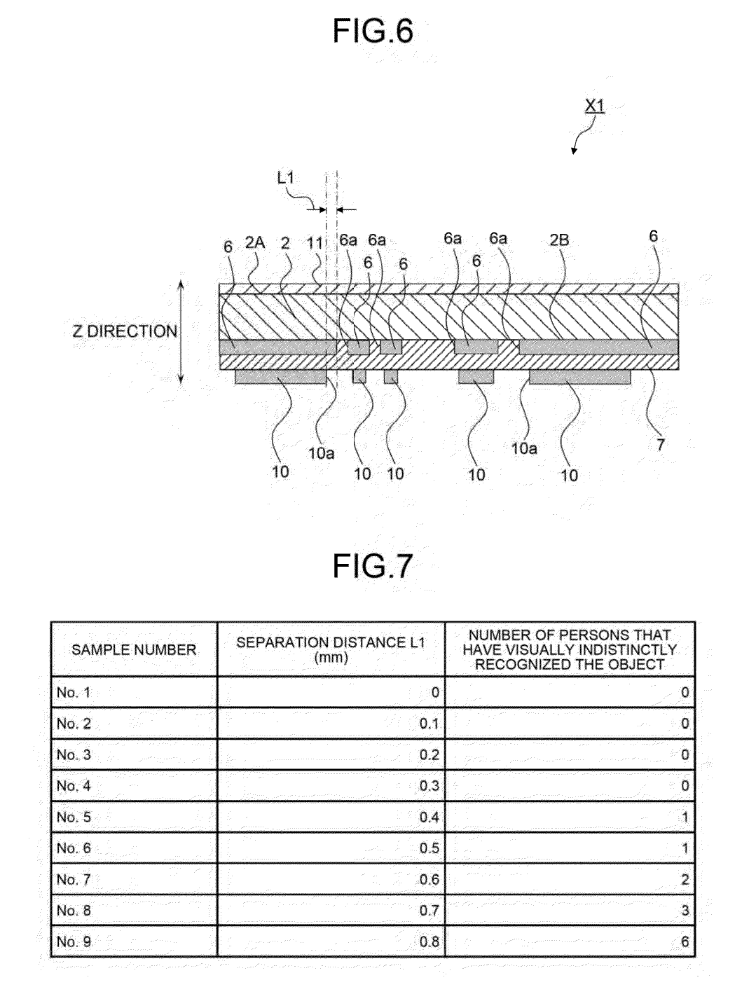

Then, the first light shielding layer 6, the first protection layer 7, the detection wire 8, the second protection layer 9, the second light shielding layer 10, and the protection sheet 11 will now be described in detail with reference to FIGS. 5 and 6 in addition to FIGS. 1 to 4. In FIG. 1, the second light shielding layer 10 is not illustrated for convenience of description.

The first light shielding layer 6 serves a role of shielding the non-input region E2 from light. The first light shielding layer 6 has therefore light shielding properties. In the embodiment, “a light shielding property” indicates a property to block a part of or the whole of incident light. The first light shielding layer 6 is provided on an area corresponding to the non-input region E2 on the second main surface 2B of the base 2. Specifically, the first light shielding layer 6 is positioned in such, a manner that surrounds the input region E1 in a planar view. In the embodiment, an edge of the first light shielding layer 6 positioned in the input region E1 side in a planar view is referred to as an inner edge 6A, and another edge of the first light shielding layer 6 positioned in the peripheral surface 2C side of the base 2 in a planar view is referred to as an outer edge 6B.

Examples of the structural material used for the first light shielding layer 6 include, but are not limited to, a resin material including therein a coloring material. Examples of such a resin material include, but are not limited to, acrylic resin, epoxy resin, and silicone resin. Examples of the coloring material include, but are not limited to, carbon, titan, and chrome. The first light shielding layer 6 may have a color phase other than black. Examples of a method to form the first light shielding layer 6 include, but are not limited to, screen printing, sputtering, chemical vapor deposition (CVD), and vapor deposition.

The first light shielding layer 6 has an opening 6a. The opening 6a serves a role of displaying a letter, a graphic, and the like. In the embodiment, the whole part of the opening 6a is positioned in the non-input region E2. In the embodiment, the opening 6a is in the shapes of letters “ABC” in a planar view. In the case where the input device X1 is installed in the display device Y1 (see FIGS. 7 to 9), for example, this configuration enables a user of a display device Y1 to visually recognize light entering from a second light source 500 through the opening 6a. In other words, the display device Y1 with the input device X1 installed therein can display designed shapes of letters “ABC”. In the embodiment, the opening 6a is in the shapes of letters “ABC” in a planar view; however, the embodiment is not limited thereto. In the embodiment, the opening 6a is positioned along the short side (the short side illustrated in the upper part of FIG. 1) of the base 2 in a planar view; however, the embodiment is not limited thereto. The shape in a planar view, the position to be placed, and the number of the opening 6a can be changed as appropriate without departing from the gist of the present invention.

The first protection layer 7 serves a role of protecting the first light shielding layer 6. Examples of the role of protecting the first light shielding layer 6 include, but are not limited to, a role of protecting the first light shielding layer 6 from corrosion resulting from absorption of moisture and a role of reducing the possibility of alteration of the material used for the first light shielding layer 6. The first protection layer 7 is provided on an area corresponding to the non-input region E2 on the second main surface 2B of the base 2 and placed on the first light shielding layer 6. In the embodiment, the first protection layer 7 covers the first light shielding layer 6. Examples of the structural material used for the first protection layer 7 include, but are not limited to, a transparent resin material. Examples of such a transparent resin material include, but are not limited to, acrylic resin, silicone resin, rubber resin, and urethane resin. Examples of a method to form the first protection layer 7 include, but are not limited to, transfer printing, spin coating, and slit coating.

The detection wire 8 serves a role of detecting a change in electrostatic capacitance generated between the first detection electrode pattern 3 and the finger F1 of a user and between the second detection electrode pattern 4 and the finger F1 of a user. A plurality of detection wires 8 are arranged on the first protection layer 7. The detection wire 8 overlaps with the first light shielding layer 6 in a planar view. This configuration can reduce the possibility that the detection wire 8 is visually recognized by a user. A plurality of detection wires 8 are divided into two groups. The detection wire 8 included in one of the groups has one of its ends connected to the first detection electrode pattern 3 and has the other end connected to an external conductive region G1. The detection wire 8 included in the other group has one of its ends electrically connected to the second detection electrode pattern 4 and has the other end connected to the external conductive region G1. The detection wire 8 is electrically connected with a position detecting driver (not illustrated) in the external conductive region G1 with a flexible printed wiring board (not illustrated) and the like interposed therebetween.

The detection wire 8 is formed in a metallic thin film so as to obtain hardness and high shape stability. Examples of the structural material used for such a metallic thin film include, but are not limited to, an aluminum film, an aluminum alloy film, a laminated film of a chrome film and an aluminum film, a laminated film of a chrome film and an aluminum alloy film, a silver film, a silver alloy film, and a gold alloy film. Examples of a method to form such a metallic thin film include, but are not limited to, sputtering, chemical vapor deposition (CVD), and vapor deposition.

The second protection layer 9 serves a role of protecting the detection wire 8. Examples of the role of protecting the detection wire 8 include, but are not limited to, a role of protecting the detection wire 8 from corrosion resulting from absorption of moisture and a role of preventing a malfunction of the detection wire 8 resulting from static electricity mixed therein. The second protection layer 9 is provided on an area corresponding to the non-input region E2 on the second main surface 2B of the base 2. Specifically, the second protection layer 9 is placed on the first protection layer 7 and covers the detection wire 8. The second protection layer 9 is not provided on the external conductive region G1. In the embodiment, the second protection layer 9 is provided on an area corresponding to the area where the detection wire 8 is arranged in a planar view; however, the embodiment is not limited thereto. The second protection layer 9 may be provided on the whole area of the non-input region E2 excluding the external conductive region G1. The same structural material and method at forming as those of the first protection layer 7 can be used for the second protection layer 9.

In the case where the input device X1 is installed in the display device Y1, for example, the second light shielding layer 10 serves a role of shielding the light entering from the second light source 500 in the vicinity of the opening 6a. The second light shielding layer 10 is provided on the first light shielding layer 6 with the first protection layer 7 interposed therebetween. The second light shielding layer 10 is arranged in such a manner that surrounds the opening 6a in a planar view. This configuration can reduce the possibility that the outer edge of the opening 6a is visually indistinctly recognised.

Specifically, a conventional input device has no second light shielding layers. In the case where an input device is installed in a display device, for example, an opening serves a role of making a user visually recognize a specific letter, graphic, or the like by making a part of or the whole of light entering from a second light source penetrate the opening. This manner may relatively increase the amount of light entering from the second light source in the peripheral area of the opening. If the amount of light entering from the second light source relatively increases in the peripheral area of the opening, a first light shielding layer, which is positioned in the peripheral area of the opening, may fail to sufficiently shield the light. If the first light shielding layer positioned in the peripheral area of the opening fails to sufficiently shield the light, the outer edge of the opening is likely to be visually indistinctly recognized in a planar view. If the outer edge of the opening is visually indistinctly recognized in a planar view, the design quality is accordingly decreased.

As described in the embodiment, in the case where a part of a first detection electrode pattern and a part of a second detection electrode pattern are arranged in such a manner that extends from an input region to a non-input region, a relative increase in thickness of the first light shielding layer may cause disconnection on the part of the first detection electrode pattern and/or the part of the second detection electrode pattern. It has therefore been difficult to relatively increase the thickness of the first light shielding layer in order to improve the light shielding properties of the first light shielding layer.

From the viewpoint of the above-described problems, the input device X1 includes the second light shielding layer 10. The second light shielding layer 10 is provided on the first light shielding layer 6 and is placed in such a manner that surrounds the opening 6a in a planar view. In the case where the input device X1 is installed in the display device Y1, for example, this configuration can improve the light shielding properties in the peripheral area of the opening 6a where a relatively large amount of light enters from the second light source 500. This configuration can therefore reduce the possibility that the outer edge of the opening 6a is visually indistinctly recognized.

In the embodiment, description that “being placed in such a manner that surrounds the opening 6a in a planar view” does not necessarily mean that the second light shielding layer 10 completely surrounds the opening 6a in a planar view. A part of the opening 6a may not be surrounded by the second light shielding layer 10 in a planar view.

It is preferable that the separation distance from the opening 6a to the second light shielding layer 10 be small to some extent in a planar view. Specifically, it is preferable that the separation distance L1 from an edge 10a, which is positioned in the closer side to the opening 6a, of the second light shielding layer 10 to the outer edge of the opening 6a be small to some extent. In the embodiment, as illustrated in FIGS. 5 and 6, the separation distance L1 particularly indicates the distance from the edge 10a, which is positioned in the leftmost side in the drawing, of the second light shielding layer 10 to the outer edge of the opening 6a on the IV-IV line substantially dividing the opening 6a in half in a planar view. The separation distance L1 may be an average value of respective distances from five points, which are selected in random from the edge 10a of the second light shielding layer 10, to the outer edge of the opening 6a.

FIG. 7 illustrates questionnaire results indicating whether the outer edge of the opening 6a is visually indistinctly recognized when the separation distance L1 is changed. Specifically, in the questionnaire, nine samples No. 1 to 9 of an input device were prepared in such a manner that the separation distance L1 sequentially becomes large. Then, 14 persons extracted in random were asked the outer edge of the opening of which sample had been visually indistinctly recognised. Except the separation distance L1, substantially the same configuration was applied to the samples No. 1 to 9. Furthermore, each of the samples No. 1 to 9 had the first light shielding layer in a thickness of 2 μm and the second light shielding layer in a thickness of 2 μm. In each of the samples No. 1 to 9, a light source was placed in the second main surface side of the base in such a manner that overlaps with the opening 6a in a planar view. The light source was configured with a single white LSD chip and had luminous intensity of 200 mcd.

As illustrated in FIG. 7, for the samples No. 1 to 6 having a separation distance L1 of equal to or smaller than 0.5 mm, 2 out of 14 persons answered that they visually indistinctly recognized the outer edges of the respective openings. In particular, for the samples No. 1 to 4 having a separation distance L1 of equal to or smaller than 0.3 mm, no one answered that the outer edges of the respective openings were visually indistinctly recognized. Hence, it is preferable that the separation distance L1 from the opening 6a to the second light shielding layer 10 be equal to or smaller than 0.5 mm. In particular, it is preferable that the separation distance L1 from the opening 6a to the second light shielding layer 10 be equal to or smaller than 0.3 mm. This configuration can further reduce the possibility that the outer edge of the opening 6a is visually indistinctly recognized in a planar view.

FIG. 6 illustrates an example where the opening 6a of the first light shielding layer 6 is smaller than the opening of the second light shielding layer 10; however, the embodiment is not limited thereto. The opening 6a of the first light shielding layer 6 may foe larger than the opening of the second light shielding layer 10.

As described in the embodiment, it is preferable that the edge 10a of the second light shielding layer 10 completely surround the opening 6a in a planar view. The shielding properties in the peripheral area of the opening 6a can be improved with the edge 10a of the second light shielding layer 10 completely surrounding the opening 6a in a planar view. In the case where the input device X1 is installed in the display device Y1, for example, this configuration can further reduce the possibility that the outer edge of the opening 6a is visually indistinctly recognized due to the light entering from the second light source 500.

As described in the embodiment, it is preferable that the edge 10a of the second light shielding layer 10 be positioned along the outer edge of the opening 6a in a planar view. The shielding properties in the peripheral area of the opening 6a can be improved with the edge 10a of the second light shielding layer 10 positioned along the outer edge of the opening 6a in a planar view. In the case where the input device X1 is installed in the display device Y1, for example, this configuration can further reduce the possibility that the outer edge of the opening 6a is visually indistinctly recognised due to the light entering from the second light source 500. In the embodiment, each of the shapes of letters “A” and “B” has the first light shielding layer 6 surrounded by the opening 6a in a planar view, and the second light shielding layer 10 is provided even on this first light shielding layer 6. This configuration can further reduce the possibility that the outer edge of the opening 6a is visually indistinctly recognized.

The protection sheet 11 serves a role of protecting the first main surface 2A of the base 2 against a scratch made by a user touching the first main surface 2A with the finger F1. The protection sheet 11 is provided on the whole area corresponding to the input region E1 and the non-input region E2 on the first main surface 2A of the base 2 with adhesive (not illustrated) interposed therebetween. The protection sheet 11 is not necessarily provided on the whole area of the first main surface 2A of the base 2. The protection sheet 11 may be exclusively provided on an area corresponding to the input region E1 on the first main surface 2A of the base 2. In another case, no protection sheet 11 may be provided. Examples of the structural material used for the protection sheet 11 include, but are not limited to, glass and plastic.

Then, the principle of detection in the input device X1 will be described.

The detection wire 8 is electrically connected with a position detecting driver (not illustrated) with a flexible printed wiring board or the like interposed therebetween. Furthermore, the detection wire 8 is electrically connected with a power supply device (not illustrated) with the flexible printed wiring board or the like interposed therebetween. The power supply device supplies voltage to the first detection electrode pattern 3 and the second detection electrode pattern 4 through the detection wire 8. When the finger F1 serving as a conductive body comes close to, touches, or presses an area corresponding to the input region E1 on the first main surface 2A of the base 2 through the protection sheet 11, electrostatic capacitance is generated between the finger F1 and the first detection electrode pattern 3 and between the finger F1 and the second detection electrode pattern 4. The position detecting driver consistently detects the electrostatic capacitance generated on the first detection electrode pattern 3 and the second detection electrode pattern 4. Based on the combination of the first detection electrode pattern 3 and the second detection electrode pattern 4 where the detected electrostatic capacitance reaches a certain value, the position detecting driver detects an input position where the user has performed an input operation. In this way, the input device X1 can detect an input position.

As described above, the input device X1 can reduce the possibility that the outer edge of the opening 6a is visually indistinctly recognized.

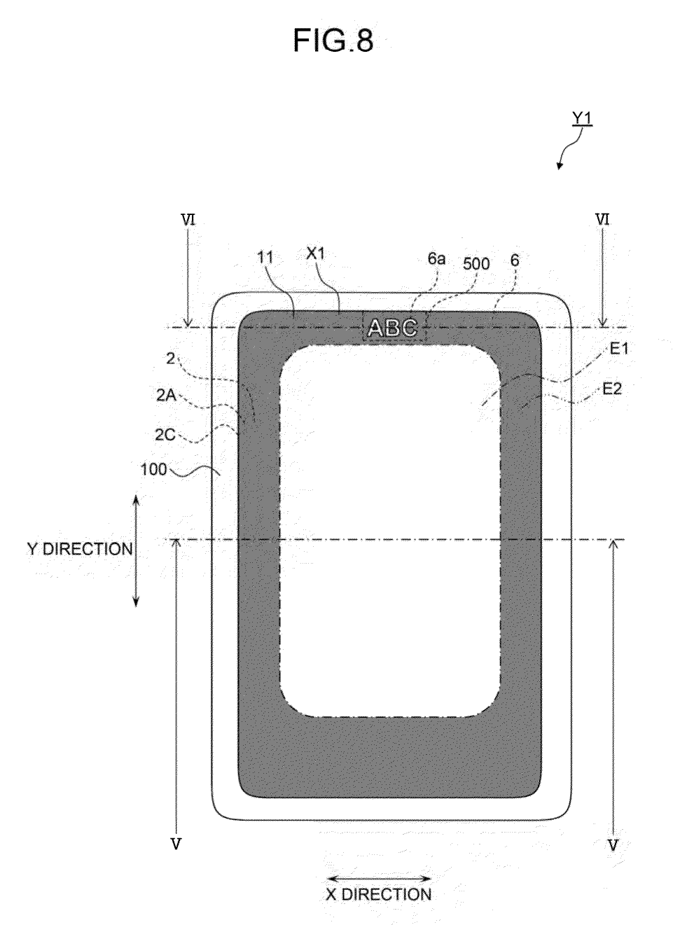

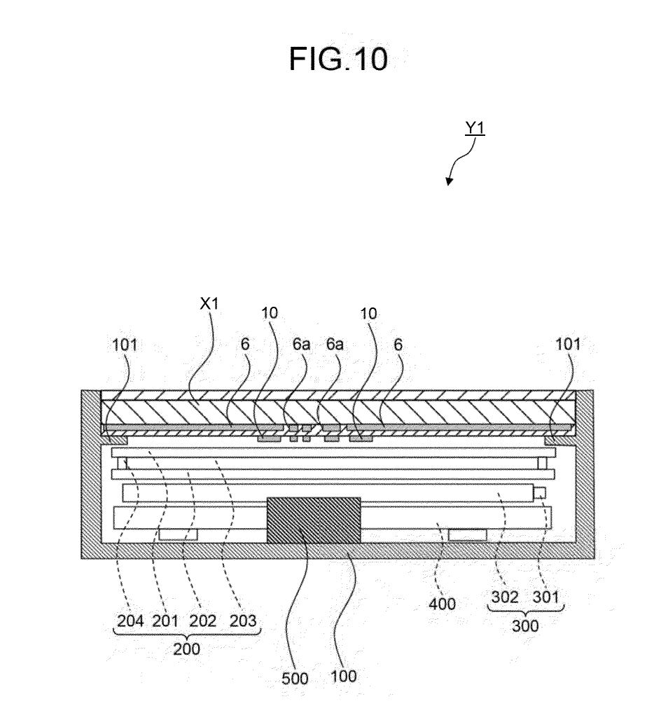

Then, the display device Y1 including the input device X1 will be described with reference to FIGS. 8 to 10.

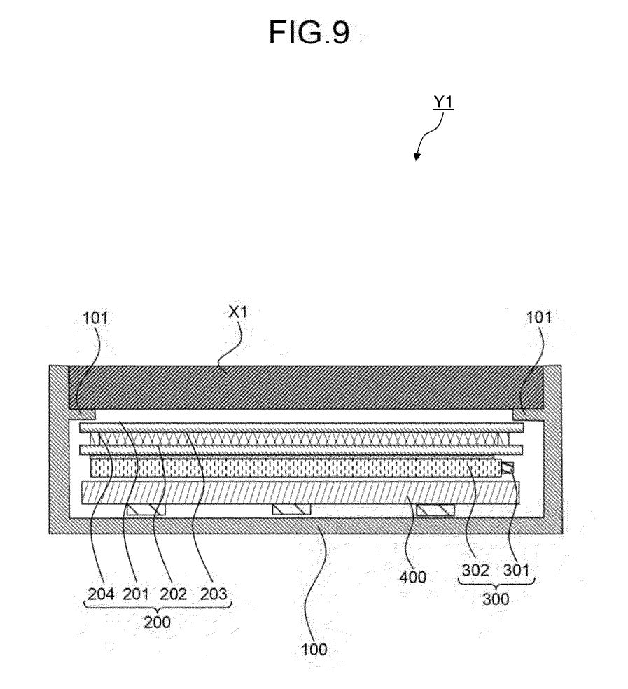

As illustrated in FIGS. 8 to 10, the display device Y1 according to the embodiment includes the input device X1, a first housing 100, a display panel 200, a backlight 300, a circuit board 400, and the second light source 500. In FIG. 8, for convenience of description, the display panel 200, the backlight 300, the circuit board 400, and the second light source 500 are not illustrated, and the area where the second light source 500 is placed is indicated with a dotted line. In FIG. 9, detailed illustration of the configuration of the input device X1 is omitted.

The first housing 100 serves a role of supporting the input device X1 and accommodating therein the display panel 200, the backlight 300, the circuit board 400, and the second light source 500. The first housing 100 has a first supporting unit 101. The first supporting unit 101 serves a role of supporting the input device X1 from the second main surface 2B side of the base 2.

Examples of the structural material used for the first housing 100 include, but are not limited to, resin such as polycarbonate and metal such as stainless and aluminum.

The display panel 200 serves a role of displaying an image and a dynamic image. The display panel 200 has an upper substrate 201, a lower substrate 202, a liquid crystal layer 203, and a searing member 204.

The upper substrate 201 is arranged in such a manner that faces the second main surface 2B of the base 2 of the input device X1. The input device X1 may be directly provided on the upper substrate 201 with a fixing member interposed therebetween. Examples of the fixing member include, but are not limited to, a double-faced tape, thermosetting resin, an optical adhesive member, and a fastener such as a screw. The lower substrate 202 is arranged in such a manner that faces the upper substrate 201. Examples of the structural material used for the upper substrate 201 and the lower substrate 202 include, but are not limited to, glass and a transparent resin material such as plastic.

The liquid crystal layer 203 is a display member layer to display an image and is provided between the upper substrate 201 and the lower substrate 202. Specifically, the liquid crystal layer 203 is sealed in an area between the upper substrate 201 and the lower substrate 202 with the upper substrate 201, the lower substrate 202, and the searing member 204. The display panel 200 according to the embodiment has the liquid crystal layer 203 serving as a display member layer; however, the embodiment is not limited thereto. Instead of the liquid crystal layer 203, the display panel 200 may have a plasma generating layer, an organic electro-luminescence layer, or the like.

The backlight 300 serves a role of making light enter the whole part of the lower surface of the display panel 200. The backlight 300 is placed in the back of the display panel 200. The backlight 300 includes a first light source 301 and a light guide plate 302. The first light source 301 serves a role of emitting light toward the light guide plate 302 and is configured with a light emitting diode (LED). The first light source 301 is not necessarily configured with an LED and may be configured with a cold cathode fluorescent lamp, a halogen lamp, a xenon lamp, electro-luminescence (EL) or the like. The light guide plate 302 serves a role of guiding light emitted from the first light source 301 in a substantially even manner. The backlight 300 may not be necessary in the case of using a display panel with a self-luminous element instead of using the display panel 200.

The circuit board 400 serves a role of supporting electronic devices such as a position detecting driver of the input device X1, a control circuit for controlling the display panel 200 and the backlight 300, a resistor, and a capacitor. The circuit board 400 is placed in the back of the backlight 300. A control circuit mounted on the circuit board 400 is electrically connected with the display panel 200 and the backlight 300 with a flexible printed wiring board (not illustrated) interposed therebetween.

The second light source 500 serves a role of emitting light toward the opening 6a and adding design to the shape of a letter or a graphic of the opening 6a. The second light source 500 is provided on the first housing 100. The second light source 500 may be provided on the display panel 200, the backlight 300, or the circuit board 400. As described in the embodiment, it is preferable that the second light source 500 overlap with the opening 6a In a planar view. If the second light source 500 overlaps with the opening 6a in a planar view, the second light source 500 can emit a relatively large amount of light onto the opening 6a, which can further enhance the design. The same structural member as that of the first light source 301 can be used for the second light source 500. The second light source 500 may be controlled to light up based on information input through an input operation performed by a user. In another way, by adding a function of wireless communication to the display device Y1, the second light source 500 may be controlled to light up based on information received via the wireless communication.

The embodiment enables a user to input various kinds of information to the display device Y1 by performing an input operation on the input region E1 of the input device X1 while seeing the display panel 200 through the input device X1. In the embodiment, the display device Y1 has the input device X1 and the display panel 200 separately configured from each other; however, the embodiment is not limited thereto. A display device including an input device according the present invention may be implemented as an in-cell or on-cell display device with an input function, in which an input device and a display panel are integrally formed.

Such a function may be added to the input device X1 that provides, when inputting various kinds of information, various kinds of tactile sensations such as a sensation of pressing, a sensation of tracing, and a sensation of skin to the user who has input information. This function is implemented by including one or a plurality of vibrating bodies (such as a piezoelectric element) in the base 2 of the input device X1 and making the vibrating body vibrate at a certain frequency in a case where a certain input operation or a certain pressing load is detected.

As described above, the display device Y1 includes the input device X1, thereby reducing the possibility that the outer edge of the opening 6a is visually indistinctly recognized.

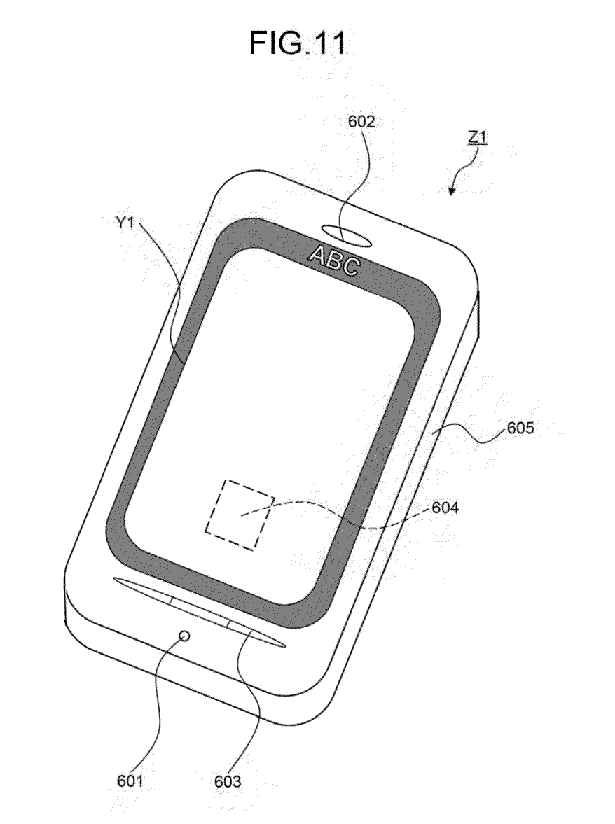

A mobile terminal Z1 including the display device Y1 will now be described with reference to FIG. 11. FIG. 11 is a perspective view of the mobile terminal Z1 including the display device Y1.

As illustrated in FIG. 11, the mobile terminal Z1 according to the embodiment is a smart phone. The mobile terminal Z1 is not limited to a smart phone but may be an electronic device such as a mobile phone, a tablet terminal, and a personal digital assistant (PDA).

The mobile terminal Z1 includes the display device Y1, a voice input unit 601, a voice output unit 602, a key input unit 603, a control unit 604, and a second housing 605.

The voice input unit 601 serves a role of inputting a voice and the like of a user and is configured with a microphone or the like. The voice output unit 602 serves a role of outputting a voice and the like of a person at the other end and is configured with an electromagnetic speaker, a piezoelectric speaker, or the like. The key input unit 603 is configured with a mechanical key. The key input unit 603 may be an operation key displayed on a display screen. The control unit 604 serves a role of controlling the voice input unit 601, the voice output unit 602, and the key input unit 603. The second housing 605 serves a role of accommodating therein the display device Y1, the voice input unit 601, the voice output unit 602, the key input unit 603, and the control unit 604. The same structural material as that of the first housing 100 may be used for the second housing 605. The first housing 100 of the display device Y1 may serve as a housing of the mobile terminal Z1, which means that the second housing 605 and the first housing 100 of the display device Y1 may be identical.

Furthermore, in accordance with a necessary function, the mobile terminal Z1 may include a digital camera function unit, a tuner for one-segment broadcasting, a short distance wireless communication unit such as an infrared communication function unit, a wireless local area network (LAN) module, various kinds of interfaces, and the like; however, details about these parts are not described or illustrated.

As described above, the mobile terminal Z1 includes the display device Y1, thereby reducing the possibility that the outer edge of the opening 6a is visually indistinctly recognized.

Instead of being included in the above-described mobile terminal Z1, the display device Y1 may be included in various kinds of electronic apparatuses such as an electronic notebook, a personal computer, a printer, a copy machine, a terminal device for games, a television, a digital camera, and a programmable display used in industrial applications.

The above-described embodiment is one of examples of the embodiment of the present invention, and various modifications can be made. The following are several main modifications.

### First Modification

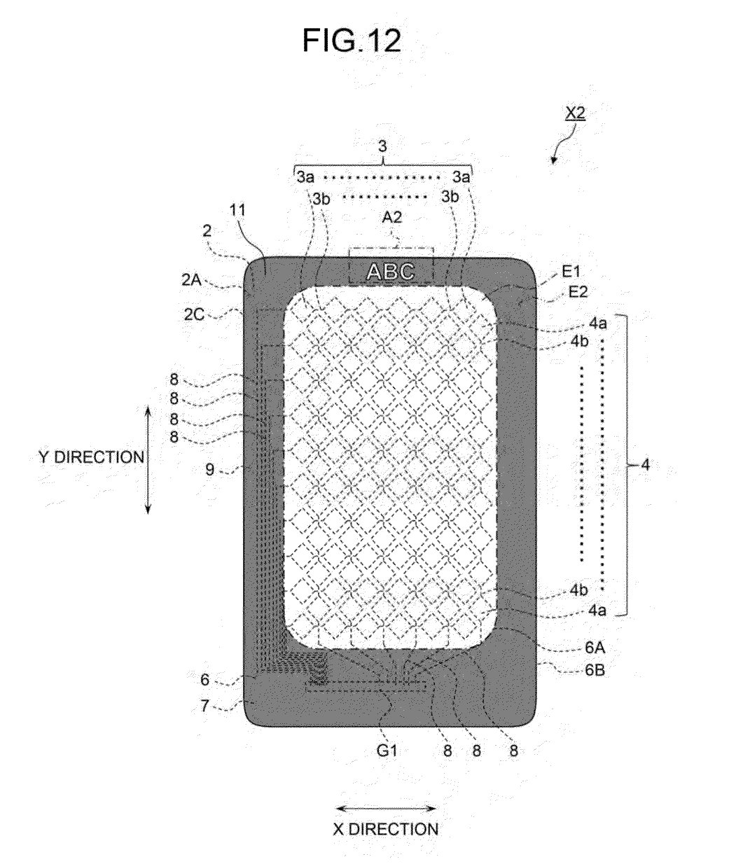

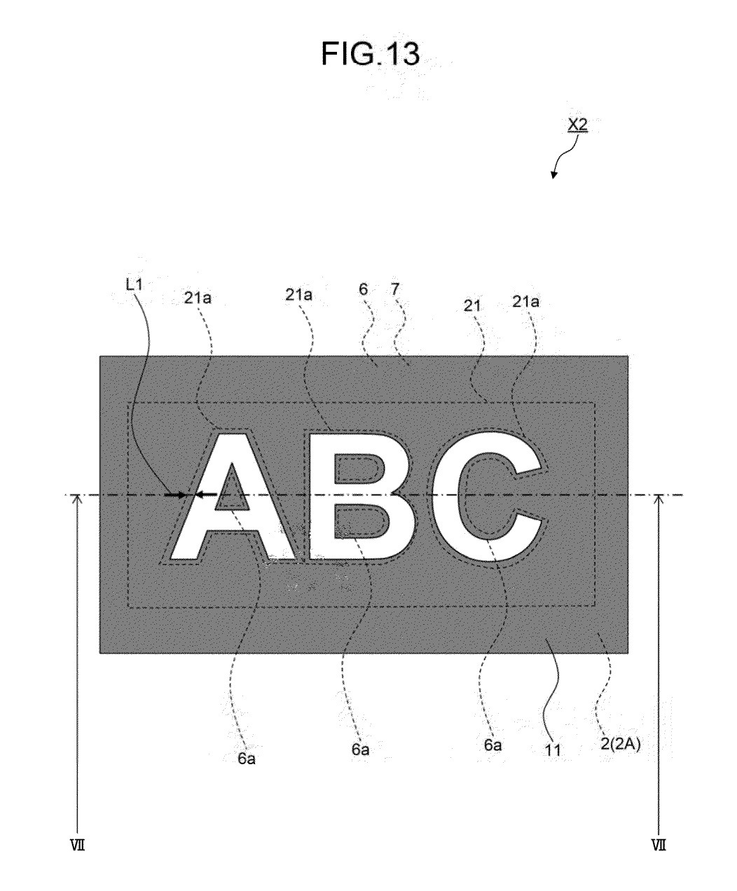

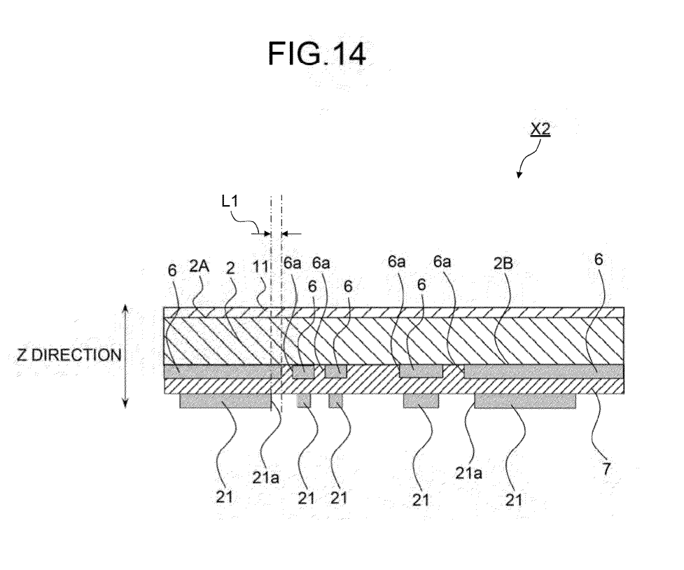

FIG. 12 is a planar view that illustrates the general configuration of an input device X2 according to a first modification. FIG. 13 is a planar magnification view of an area A2 circled with a dotted chain line illustrated in FIG. 12. FIG. 14 is a sectional view along the VII-VII line illustrated in FIG. 13. In FIGS. 12 to 14, like numerals indicate like components that share the same functions as those in FIGS. 1, 5, and 6, and details about those components well not be described.

As illustrated in FIGS. 12 to 14, the input device X2 includes a second light shielding layer 21 instead of the second light shielding layer 10 of the input device X1.

The second light shielding layer 21 is provided on the first light shielding layer 6. Specifically, the second light shielding layer 21 is provided on the first protection layer 7 corresponding to the non-input region E2 and is arranged in such a manner that surrounds the opening 6a in a planar view.

The second light shielding layer 21 is made from a metallic material, and use of a metallic material for the second light shielding layer 21 can relatively improve light shielding properties compared with the second light shielding layer 10 of the input device X1. Accordingly, in the case where the input device X2 instead of the input device X1 is installed in the display device Y1, for example, the light shielding properties can be further improved in the peripheral area of the opening 6a where a relatively large amount of light enters from the second light source 500. This configuration can therefore reduce the possibility that the outer edge of the opening 6a is visually indistinctly recognized in a planar view.

As described above, the peripheral area of the opening 6a receives a relatively large amount of light entering from the second light source 500. Heat generated by the light may cause deterioration of the material and thus cause a decrease of light shielding properties in the second light shielding layer 10 of the input device X1. Considering such a problem, the second light shielding layer 21 is made from a metallic material, thereby reducing the possibility that the light shielding properties are decreased due to heat of the light.

In the first modification, the second light shielding layer 21 is made from the same material as that of the detection wire 8. The second light shielding layer 21 can be thus formed together with the detection wire 8 in a process to form the detection wire 8, and the manufacturing process can be thus simplified. As a method to form the detection wire 8, techniques to form a thin film such as sputtering, chemical vapor deposition (CVD), and vapor deposition are useful to improve the positioning accuracy in forming the detection wire 8. In other words, such techniques can relatively shorten the separation distance from the opening 6a to the second light shielding layer 21 in a planar view and can accordingly further reduce the possibility that the outer edge of the opening 6a is visually indistinctly recognised in a planar view. The second light shielding layer 21 may be manufactured in a different process from that of the detection wire 8.

In the first modification, the second light shielding layer 21 is positioned between the peripheral surface 2C of the base 2 and the first detection electrode pattern 3 and between the peripheral surface 2C of the base 2 and the second detection electrode pattern 4 in a planar view. In the case where the input device X2 instead of the input device X1 is installed in the display device Y1, for example, a noise caused by electrostatic discharge may be mixed into the first detection electrode pattern 3 and the second detection electrode pattern 4 from the gap between the peripheral surface 2C of the base 2 and the first housing 100. In the first modification, use of the second light shielding layer 21 made from a metallic material can reduce the possibility that a noise caused by electrostatic discharge is mixed into the first detection electrode pattern 3 and the second detection electrode pattern 4. The second light shielding layer 21 is not necessarily positioned between the peripheral surface 2C of the base 2 and the first detection electrode pattern 3 or between the peripheral surface 2C of the base 2 and the second detection electrode pattern 4 in a planar view. The position of the second light shielding layer 21 can be changed as appropriate based on the position of the opening 6a.

### Second Modification

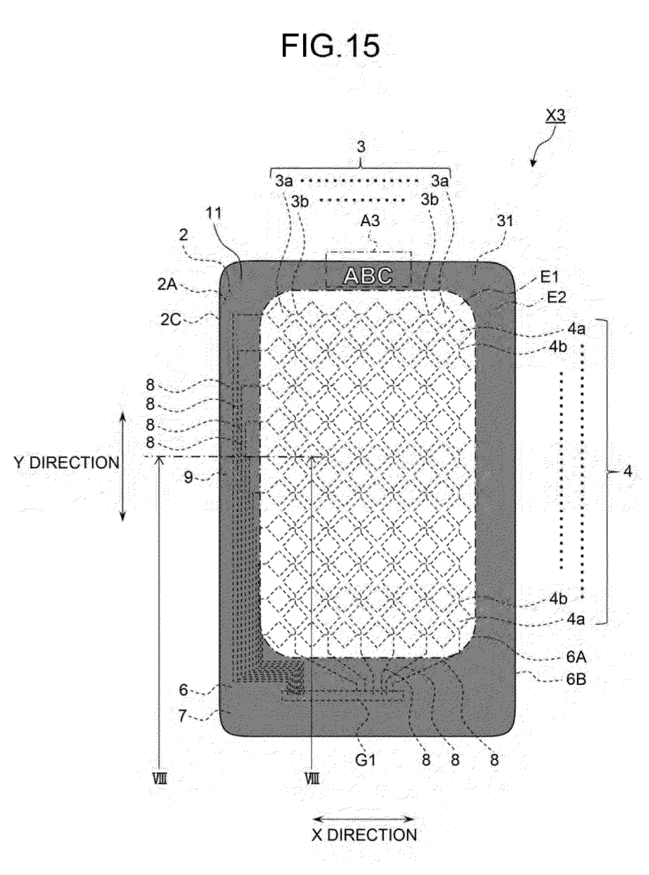

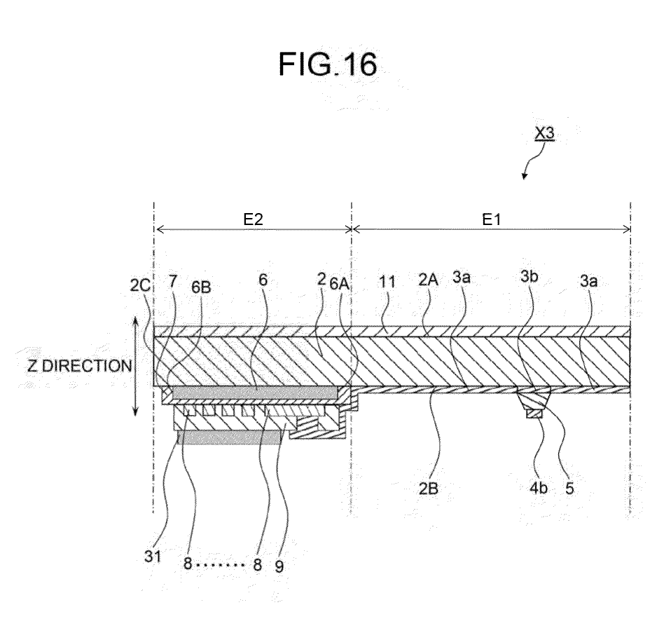

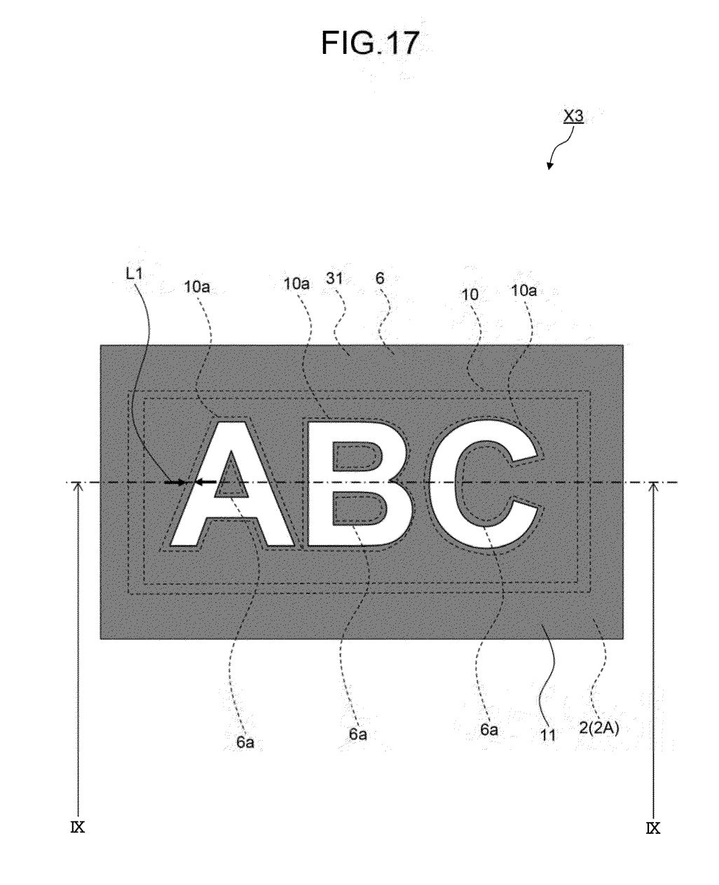

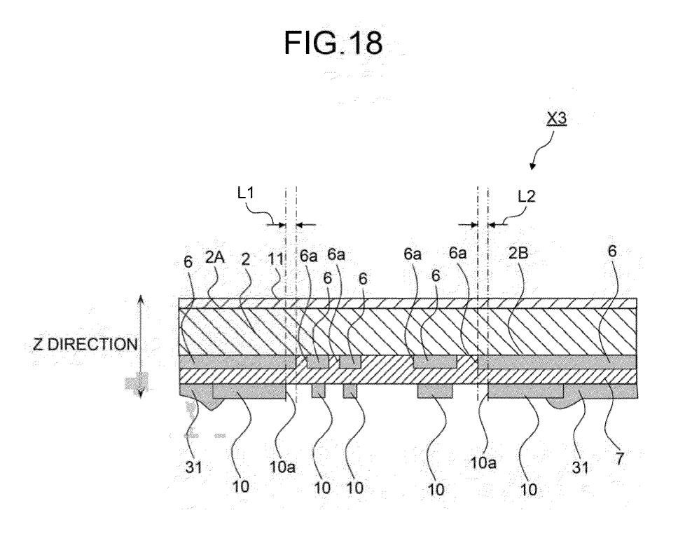

FIG. 15 is a planar view that illustrates the general configuration of an input device X3 according to a second modification. FIG. 16 is a sectional view along the VIII-VIII line illustrated in FIG. 15. FIG. 17 is a planar magnification view of an area A3 circled with a dotted chain line illustrated in FIG. 15. FIG. 18 is a sectional view along the IX-IX line illustrated in FIG. 17. In FIGS. 15 to 18, like numerals indicate like components that share the same functions as those in FIG. 1 and FIGS. 4 to 6, and details about those components will not be described.

As illustrated in FIGS. 15 to 18, the input device X3 further includes a third light shielding layer 31.

In the case where the input device X3 instead of the input device X1 is installed in the display device Y1, for example, the third light shielding layer 31 serves a role of shielding light entering from the first light source 301 and the second light source 500. The third light shielding layer 31 is provided on the first light shielding layer 6 corresponding to the non-input region E2. Specifically, the third light shielding layer 31 is provided on the first protection layer 7 and on the second protection layer 9 each corresponding to the non-input region E2. The third light shielding layer 31 is arranged in such a manner that overlaps with the detection wire 8 in a planar view. In the case where the input device X3 instead of the input device X1 is installed in the display device Y1, for example, even if a relatively large amount of light entering from the first light source 301 is applied onto an area corresponding to the non-input region E2 on the input device X3, this configuration can reduce the possibility that the detection wire 8 is visually recognized through the light.

Furthermore, the third light shielding layer 31 contacts with the second light shielding layer 10. Specifically, a part of the third light shielding layer 31 overlaps with the second light shielding layer 10 in a planar view. This configuration can reduce the possibility that the color tones change between an area where the first light shielding layer 6 and the second light shielding layer 10 overlap with each other in a planar view and another area having only the first light shielding layer 6.

The same structural material as that of the first light shielding layer 6 may be used for the third light shielding layer 31.

### Third Modification

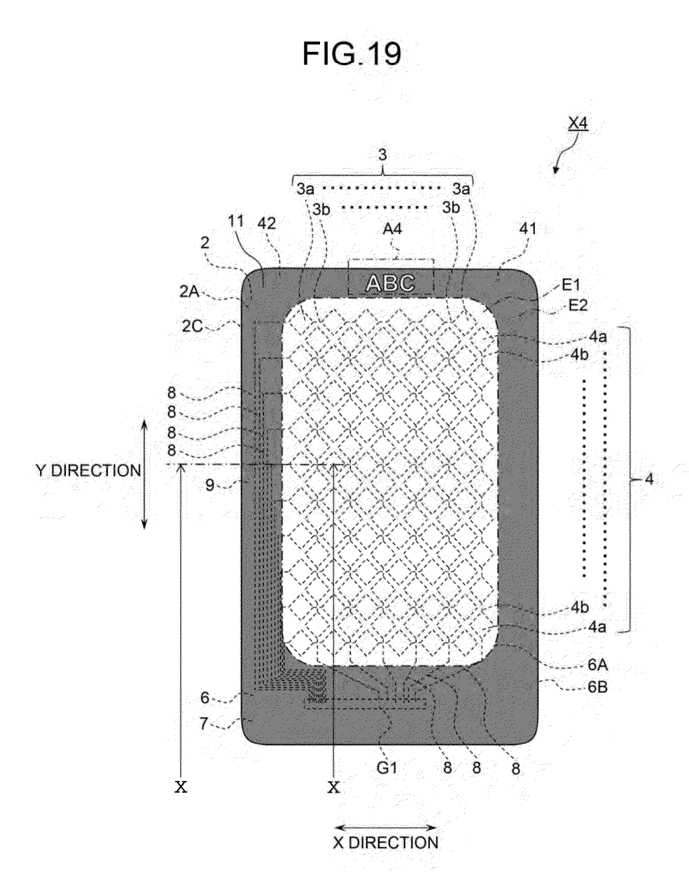

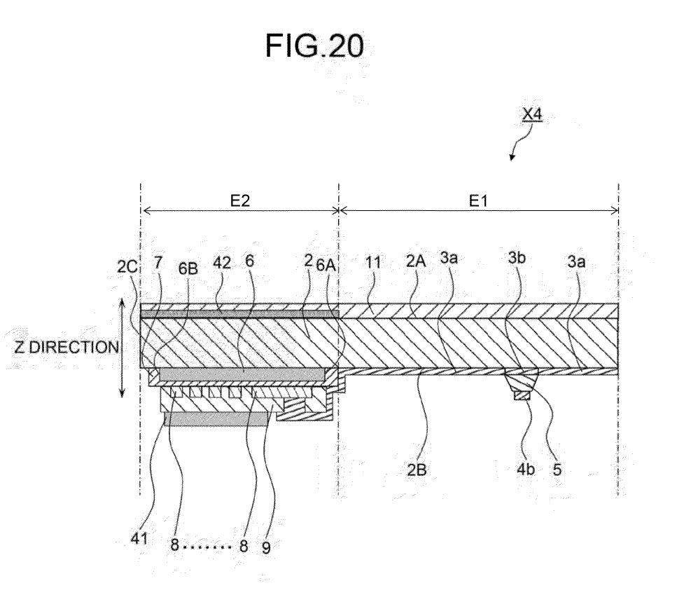

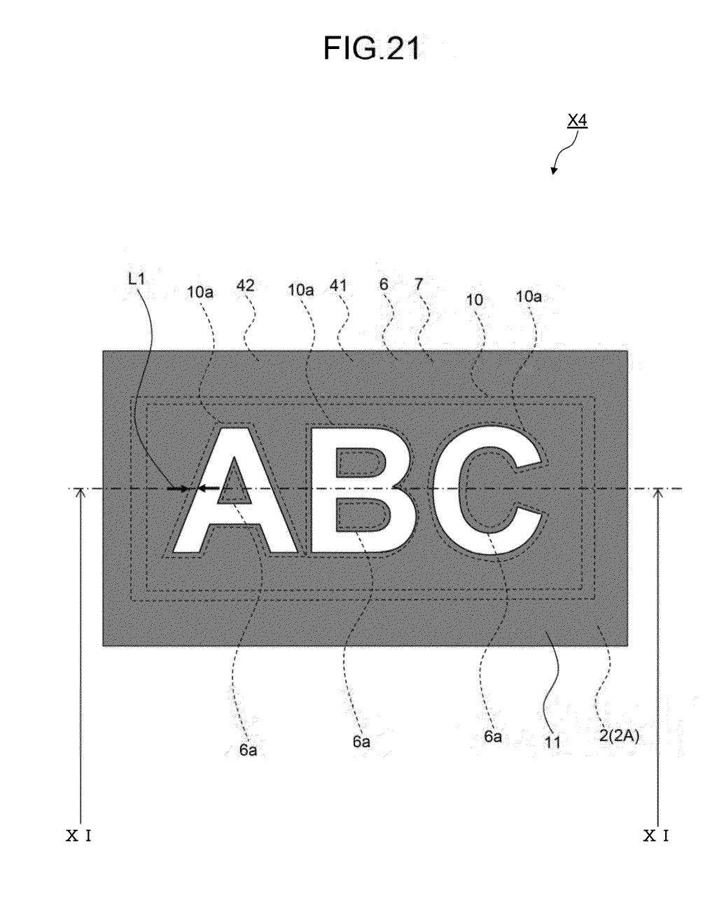

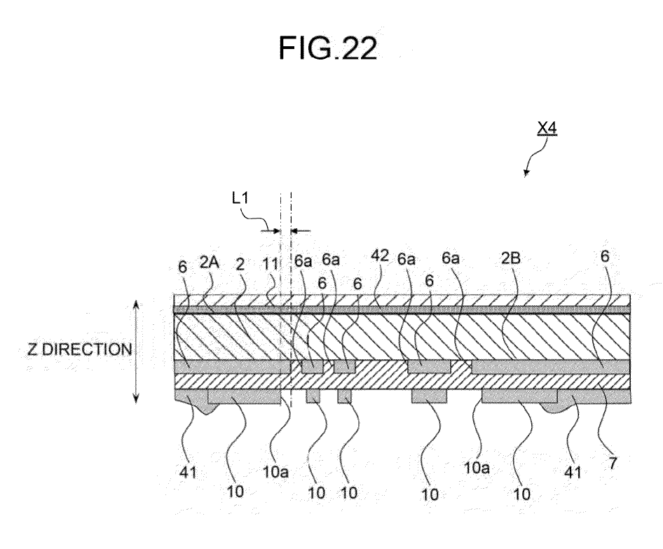

FIG. 19 is a planar view that illustrates the general configuration of an input device X4 according to a third embodiment. FIG. 20 is a sectional view along the X-X line illustrated in FIG. 19. FIG. 21 is a planar magnification view of an area A4 circled with a dotted chain line illustrated in FIG. 19. FIG. 22 is a sectional view along the XI-XI line illustrated in FIG. 21. In FIGS. 19 to 22, like numerals indicate like components that share the same functions as those in FIG. 1 and FIGS. 4 to 6, and details about those components will not be described.

As illustrated in FIGS. 19 to 22, the input device X4 further includes a third light shielding layer 41 and a decorating layer 42.

In the case where the input device X4 instead of input device. X1 is installed in the display device Y1, for example, the third light shielding layer 41 serves a role of shielding light entering from the first light source 301 and the second light source 500. The third light shielding layer 41 is provided on the first light shielding layer 6 corresponding to the non-input region E2. Specifically, the third light shielding layer 41 is provided on the first protection layer 7 and the second protection layer 9 each corresponding to the non-input region E2. The third light shielding layer 41 is arranged in such a manner that overlaps with the detection wire 8 in a planar view. A part of the third light shielding layer 41 overlaps with the second light shielding layer 10 in a planar view. The same structural material as that of the third light shielding layer 31 may be used for the third light shielding layer 41.

The decorating layer 42 serves a role of decorating the non-input region E2. The decorating layer 42 is provided on the whole area corresponding to the non-input region E2 on the first main surface 2A of the base 2. The decorating layer 42 is arranged in such a manner that overlaps with the opening 6a in a planar view. The decorating layer 42 is translucent. Specifically, the decorating layer 42 is configured to have a smaller light shielding property than that of the first light shielding layer 6 and makes a part of or the whole of visible light penetrate the decorating layer 42. In the case where the input device X4 instead of the input device X1 is installed in the display device Y1, for example, this configuration allows light emitted from the second light source 500 to pass through the opening 6a, penetrate the decorating layer 42, and to be visually recognized. In other words, when using the display device Y1 with the input device X4 installed thereto, the user can visually recognize the shape of a letter or graphic of the opening 6a through the decorating layer 42. This manner can enhance the design.

The same structural material as that of the first light shielding layer 6 and the second light shielding layer 10 may be used for the decorating layer 42. However, from the viewpoint of enhancing the design, it is preferable that the decorating layer 42 has a different color phase from that of the first light shielding layer 6 or the second light shielding layer 10.

In the third modification, the decorating layer 42 is provided on the whole area corresponding to the non-input region E2 on the first main surface 2A of the base 1; however, the embodiment is not limited thereto. In another case, the decorating layer 42 may be provided on an area corresponding to the non-input region E2 on the second main surface 2B of the base 1 and overlap with the opening 6a in a planar view. A part of the decorating layer 42 may be positioned inside the opening 6a.

### Fourth Modification

In the description, the embodiment and the first to the third modifications each have been described in detail; however, without being limited thereto, the description includes other examples where matters described in each of the embodiment and the first to the third modifications are combined as appropriate. In other words, an input device according to the present invention is not limited to the input devices X1 to X4 but includes other input devices where matters described in each of the embodiment and the first to the third modifications are combined as appropriate.

In the above-described embodiment, the display device Y1 including therein the input device X1 has been described; however, the embodiment is not limited thereto. Input devices X2 to X4 may replace the input device X1. Furthermore, in the above-described embodiment, the mobile terminal Z1 including therein the input device X1 has been described; however, the embodiment is not limited thereto. Input devices X2 to X4 may replace the input device X1.

### REFERENCE SIGNS LIST

X1 to X4 input device

Y1 display device

Z1 mobile terminal (electronic apparatus)

2 base

2A first main surface 2A

2B second main surface 2B

3a first detection electrode

4a second detection electrode

6 first light shielding layer

6a opening

7 first protection layer

8 detection wire

9 second protection layer

10 and 21 second light shielding layer

10a and 21a edge

31 and 41 third light shielding layer

100 first housing

200 display panel

500 second light source (light source)

601 voice input unit

602 voice output unit

604 control unit

605 second housing

1. An input device, comprising:
a base;
a first light shielding layer that is provided on the base and has an opening; and
a second light shielding layer that is provided on the first light shielding layer and is placed in such a manner that surrounds the opening in a planar view.

2. The input device according to claim 1, wherein
the first light shielding layer and the second light shielding layer are placed in a non-input region.

3. The input device according to claim 2, wherein the whole part of the opening is placed in the non-input region.

4. The input device according to claim 2, wherein the second light shielding layer is made from a metallic material.

5. The input device according to claim 4, further comprising:
a detection electrode that is provided on an area corresponding to a input region on the base; and
a detection wire that is provided on the first light shielding layer corresponding to the non-input region and is electrically connected with the detection electrode, wherein
the detection wire is made from a metallic material identical to a material of the second light shielding layer.

6. The input device according to claim 5, wherein
the input device further comprises a first protection layer that is provided on the base and placed on the first light shielding layer,
the second light shielding layer and the detection wire are placed on the first protection layer, and
the input device further comprises a second protection layer that is provided on the first protection layer and covers tire detection wire.

7. The input device according to claim 1, wherein a distance from the opening to the second light shielding layer is equal to or smaller than 0.5 mm in a planar view.

8. The input device according to claim 7, wherein a distance from the opening to the second light shielding layer is equal to or smaller than 0.3 mm in a planar view.

9. The input device according to claim 1, wherein the second light shielding layer completely surrounds the opening in a planar view.

10. The input device according to claim 1, wherein the second light shielding layer is arranged in such a manner that fits along an outer edge of the opening in a planar view.

11. The input device according to claim 5, further comprising:
a third light shielding layer that is provided on the first light shielding layer corresponding to the non-input region, wherein
the third light shielding layer overlaps with the detection wire in a planar view.

12. The input device according to claim 11, wherein the third light-shielding layer contacts with the second light shielding layer.

13. The input device according to claim 1, further comprising:
a decorating layer that is placed in such a manner that overlaps with the opening in a planar view and is translucent.

14. The input device according to claim 1, wherein the opening has a function to display a specific letter or graphic.

15. A display device, comprising:
the input device according to claim 1;
a display panel that is arranged in such a manner that faces the input device; and
a first housing that accommodates the display panel.

16. The display device according to claim 15, further comprising:
a light source that is accommodated in the housing and is placed in such a manner that overlaps with the opening of the input device in a planar view.

17. An electronic apparatus, comprising:
the display device according to claim 15, wherein the first housing of the display device serves as a housing of the electronic apparatus.

18. An electronic apparatus, comprising:
the display device according to claim 15; and
a second housing that accommodates the display device.

19. The electronic apparatus according to claim 17, further comprising:
a voice input unit to which a voice is input;
a voice output unit from which a voice is output; and
a control unit that controls the voice input unit and the voice output unit.

20. The electronic apparatus according to claim 18, further comprising:
a voice input unit to which a voice is input;
a voice output unit from which a voice is output; and
a control unit that controls the voice input unit and the voice output unit.
